(19) United States
(12) Patent Application Publication
(10) Pub. No.: US 2025/0309670 A1
(43) Pub. Date: Oct. 2, 2025

(54) BATTERY CHARGING METHOD AND DEVICE

(71) Applicant: Delta Electronics, Inc., Taoyuan City (TW)

(72) Inventors: Sheng-Jian Chen, Taoyuan City (TW); Kun-Jang Kuo, Taoyuan City (TW); Chia-Chang Hsu, Taoyuan City (TW); Wei-Ting Chen, Taoyuan City (TW); Shu-Hao Chang, Taoyuan City (TW); Sheng-Yuan Ou, Taoyuan City (TW); Chi-Ting Ko, Taoyuan City (TW); Wen-Ching Yen, Taoyuan City (TW); Chieh-Cheng Wang, Taoyuan City (TW)

(21) Appl. No.: 18/883,211

(22) Filed: Sep. 12, 2024

(30) Foreign Application Priority Data
Apr. 1, 2024 (CN) 202410385529.3

(51) Int. Cl. H02J 7/00

(52) U.S. Cl. CPC H02J 7/0071; H02J 7/0047; H02J 7/00712; H02J 2207/40

(57) ABSTRACT

A battery charging method and a battery charging device are provided. The battery charging method includes: during a first time interval of a charging period, configuring a DC current generation circuit to generate a DC current, and charging a battery by a charging current including the DC current; and during a second time interval of the charging period, configuring a sinusoidal current generation circuit to generate a sinusoidal current, and charging the battery by the charging current including the DC current and the sinusoidal current. A minimum value of the charging current is equal to the DC current.

### CROSS-REFERENCE TO RELATED APPLICATION

This application claims priority to China Patent Application No. 202410385529.3 filed on Apr. 1, 2024. The entire contents of the above-mentioned patent application are incorporated herein by reference for all purposes.

### FIELD OF THE INVENTION

The present disclosure relates to a charging method and device, and more particularly to a battery charging method and device.

### BACKGROUND OF THE INVENTION

Conventional battery charging methods typically utilize constant-current charging combined with constant-voltage charging to ensure that the battery would be fully charged. However, nowadays, the demand for fast charging requires the ability of effectively reducing charging time. Meanwhile, avoiding the excessive temperature rise of battery caused by charging, which may reduce the lifespan of battery, is also required.

Therefore, there is a need of providing a battery charging method and device in order to overcome the drawbacks of the conventional technologies.

### SUMMARY OF THE INVENTION

The present disclosure provides a battery charging method and a battery charging device in order to overcome the drawbacks of conventional technologies.

In accordance with an aspect of the present disclosure, a battery charging method is provided. The battery charging method includes: during a first time interval of a charging period, configuring a DC current generation circuit to generate a DC current, and charging a battery by a charging current including the DC current; and during a second time interval of the charging period, configuring a sinusoidal current generation circuit to generate a sinusoidal current, and charging the battery by the charging current including the DC current and the sinusoidal current. A minimum value of the charging current is equal to the DC current.

In accordance with another aspect of the present disclosure, a battery charging device is provided. The battery charging device includes a sinusoidal current generation circuit, a DC current generation circuit, and a control circuit. The control circuit is coupled to the sinusoidal current generation circuit and the DC current generation circuit. During a first time interval of a charging period, the control circuit configures the DC current generation circuit to generate a DC current, and a charging current including the DC current charges a battery. During a second time interval of the charging period, the control circuit configures the sinusoidal current generation circuit to generate a sinusoidal current, and the charging current including the DC current and the sinusoidal current charges the battery. A minimum value of the charging current is equal to the DC current.

The above embodiments can effectively reduce the charging time of battery and achieve the balance between charging speed and battery temperature to maintain the lifespan of battery.

### BRIEF DESCRIPTION OF THE DRAWINGS

FIG. 1 is a schematic block diagram illustrating a battery charging device and a battery according to an embodiment of the present disclosure;

FIG. 2 schematically shows an embodiment of an AC impedance model of the battery of FIG. 1;

FIG. 3 is a schematic flow chart illustrating a battery charging method according to an embodiment of the present disclosure;

FIG. 4 is a schematic flow chart illustrating a battery charging method according to another embodiment of the present disclosure; and

FIG. 5 schematically shows waveforms of the charging current according to an embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only.

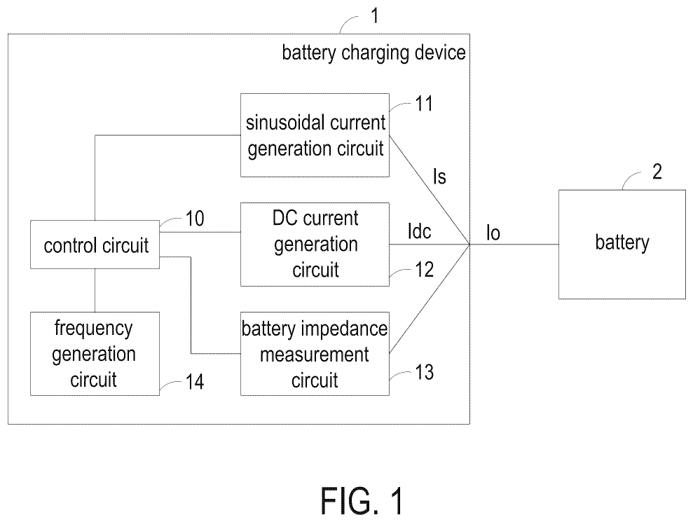

FIG. 1 is a schematic block diagram illustrating a battery charging device and a battery according to an embodiment of the present disclosure. As shown in FIG. 1, the battery charging device 1 is configured to charge the battery 2. In this embodiment, the battery charging device 1 includes a control circuit 10, a sinusoidal current generation circuit 11, a DC current generation circuit 12, a battery impedance measurement circuit 13, and a frequency generation circuit 14. For the sake of brevity, other components of the battery charging device 1 are not depicted in FIG. 1. In this embodiment, the battery charging device 1 is divided into the control circuit 10, the sinusoidal current generation circuit 11, the DC current generation circuit 12, the battery impedance measurement circuit 13, and the frequency generation circuit 14 for clearly describing the operation of the battery charging device 1. The said circuits may be implemented by suitable circuit components respectively, or the said circuits may be integrated into or separately implemented by one or more circuit components. For example, the control circuit 10 and the battery impedance measurement circuit 13 may be integrated into a microcontroller, and the sinusoidal current generation circuit 11 and the DC current generation circuit 12 may be integrated into a current generation circuit which is configured by the control circuit 10 to provide the required charging current. In another embodiment, the functions of the control circuit 10, the sinusoidal current generation circuit 11, and the DC current generation circuit 12 may be performed by the same circuit formed by discrete components and/or integrated circuit components. The control circuit 10 may include logic circuitries and is used to control the operation of the sinusoidal current generation circuit 11, the DC current generation circuit 12, the battery impedance measurement circuit 13, and the frequency generation circuit 14. For example, according to signals from the frequency generation circuit 14, the control circuit 10 configures the sinusoidal current generation circuit 11 to generate a sinusoidal current Is and configures the DC current generation circuit 12 to generate a DC current Idc at appropriate times. The DC current generation circuit 12 may adopt suitable circuit structure, such as DC-DC converter or AC-DC converter, to provide the required DC current Idc. In an embodiment, the frequency generation circuit 14 includes an oscillator circuit and outputs one or more periodic signals of a fixed frequency, which allow the control circuit 10 to estimate time according to the one or more periodic signals and to accordingly configure the operation of the other circuits. For example, the control circuit 10 controls the time interval, in which the sinusoidal current generation circuit 11 generates the sinusoidal current Is, and the frequency of the sinusoidal current Is according to the one or more periodic signals.

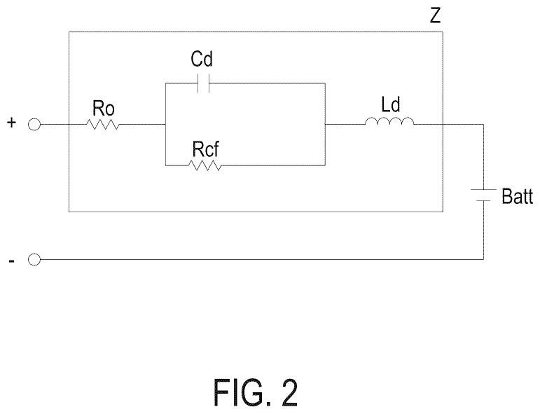

During the process of charging the battery 2 by the sinusoidal current Is, the frequency of the sinusoidal current Is is correlated with the charging speed and temperature rise of the battery 2. FIG. 2 schematically shows an embodiment of an AC impedance model of the battery 2. As shown in FIG. 2, in this AC impedance model, an equivalent impedance Z includes an ohm resistor Ro, an equivalent capacitor Cd, an electrode inductor Ld, and an ideal battery Batt electrically connected in series, and the equivalent capacitor Cd is electrically connected in parallel to a resistor Rcf. According to this model, when the battery 2 is charged by the sinusoidal current Is, the equivalent impedance Z of the battery 2 would change if the frequency of the sinusoidal current Is changes. The control circuit 10 appropriately configures the frequency of the sinusoidal current Is generated by the sinusoidal current generation circuit 11 to match the equivalent impedance Z of the battery 2. In other words, matching the equivalent impedance Z of the battery 2 is to reduce the equivalent impedance Z of the battery 2 which varying with frequency, thereby reducing energy loss to improve charging efficiency and reducing the temperature rise caused by waste heat.

In view of this, in this embodiment, the control circuit 10 may configure the battery impedance measurement circuit 13 to measure the equivalent impedance Z of the battery 2. Based on the equivalent impedance Z of the battery 2, the control circuit 10 configures the frequency of the sinusoidal current Is generated by the sinusoidal current generation circuit 11 to match the equivalent impedance Z of the battery 2. Consequently, the battery 2 is charged by the charging current Io with better efficiency, and hence the charging efficiency is further improved. For example, the frequency of the sinusoidal current Is is configured to let the equivalent impedance Z of the battery 2 be close to its minimum value, thereby achieving better energy transfer efficiency and meanwhile avoiding significant temperature rise of the battery 2 for improving the lifespan. For instance, the control circuit 10 configures the sinusoidal current generation circuit 11 to transmit sinusoidal signals of a certain frequency to the battery 2, and configures the battery impedance measurement circuit 13 to measure the equivalent impedance Z of the battery 2 corresponding to the sinusoidal signals of that certain frequency. In another embodiment, the control circuit 10 configures the sinusoidal current generation circuit 11 to transmit sinusoidal signals of multiple frequencies to the battery 2, and configures the battery impedance measurement circuit 13 to measure the equivalent impedance Z. When the equivalent impedance Z is small, the control circuit 10 records the frequency of the corresponding sinusoidal signal. In another embodiment, the battery charging device 1 is used to charge batteries with a particular specification. Since the characteristics of the batteries are similar, the battery charging device 1 may not include the battery impedance measurement circuit 13 and the related measurement steps, and the control circuit 10 configures the sinusoidal current generation circuit 11 to charge the battery 2 by the sinusoidal current Is of a configured frequency.

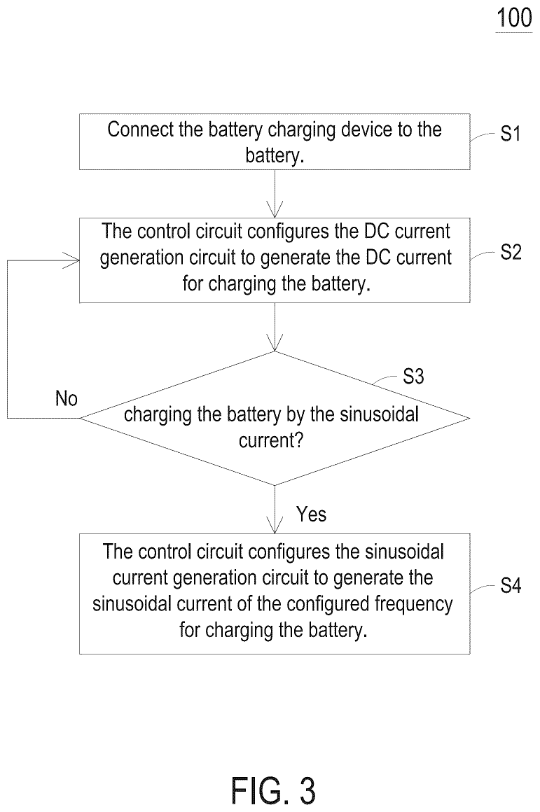

FIG. 3 is a schematic flow chart illustrating a battery charging method according to an embodiment of the present disclosure. The battery charging method is applicable for the battery charging device 1 shown in FIG. 1. Please refer to FIG. 3 with FIG. 1. The battery charging method 100 includes the following steps. In step S1, the battery charging device 1 is connected to the battery 2. In step S2, the control circuit 10 configures the DC current generation circuit 12 to generate the DC current Idc for charging the battery 2. In step S3, according to the output of the frequency generation circuit 14, the control circuit 10 determines whether to configure the sinusoidal current generation circuit 11 to generate the sinusoidal current Is for charging the battery 2. In step S4, the control circuit 10 configures the sinusoidal current generation circuit 11 to generate the sinusoidal current Is of the configured frequency for charging the battery 2. In each charging period T of the battery charging device 1 providing the charging current Io to the battery 2, the charging current Io includes the DC current Idc during the time interval T1, and the charging current Io includes the DC current Idc plus the sinusoidal current Is during the time interval T2. Therefore, the minimum value of the charging current Io is equal to the DC current Idc.

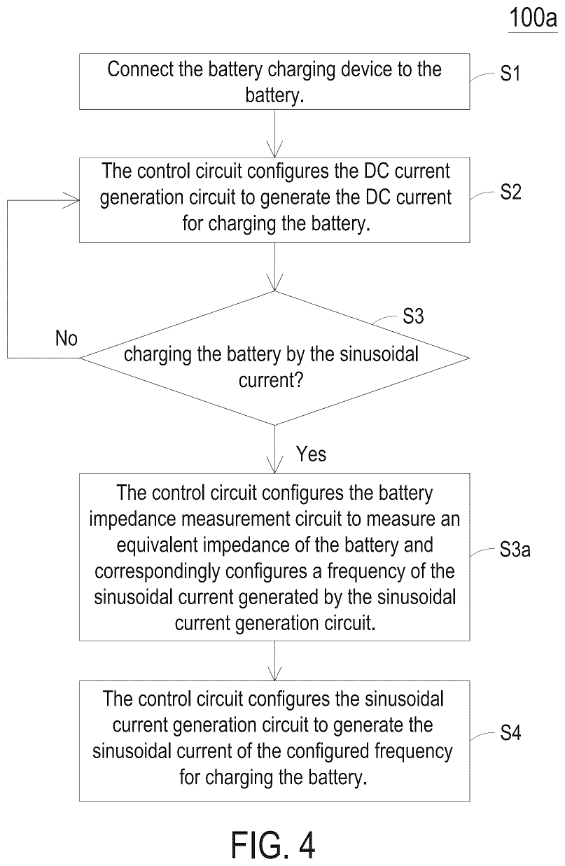

In order to let the sinusoidal current generation circuit 11 generate the sinusoidal current Is, for charging the battery 2, of a certain frequency which matches the equivalent impedance Z of the battery 2 to achieve optimal charging efficiency, in an embodiment, as shown in FIG. 4 (with FIG. 1), the battery charging method 100a of the present disclosure further includes a step S3a. In FIG. 4, the steps similar to that of the battery charging method 100 shown in FIG. 3 are designated by the same numeral references, and thus the detailed descriptions thereof are omitted herein. In the step S3a of this embodiment, the control circuit 10 configures the battery impedance measurement circuit 13 to measure the equivalent impedance Z of the battery 2, and according to the measurement result of the battery impedance measurement circuit 13, the control circuit 10 configures the frequency of the sinusoidal current Is generated by the sinusoidal current generation circuit 11 to match the equivalent impedance Z of the battery 2. Thereby, the charging efficiency is improved.

In an embodiment, the step S3a may be performed only once, and in the follow-up charging process, the control circuit 10 configures the sinusoidal current generation circuit 11 to generate the sinusoidal currents Is of the same frequency for charging the battery 2. In another embodiment, the step S3a may be performed every preset duration or every preset variation of the battery charging level to deal with variations in the equivalent impedance Z of the battery 2 due to different battery charging levels. In another embodiment, the step S3a may be performed to measure the equivalent impedance Z of the battery 2 before each time the control circuit 10 configures the sinusoidal current generation circuit 11 to generate the sinusoidal current Is.

The battery charging method of the above embodiments may be combined with other steps such as pre-charging, constant-voltage charging, or stopping charging, which are not depicted in the figures.

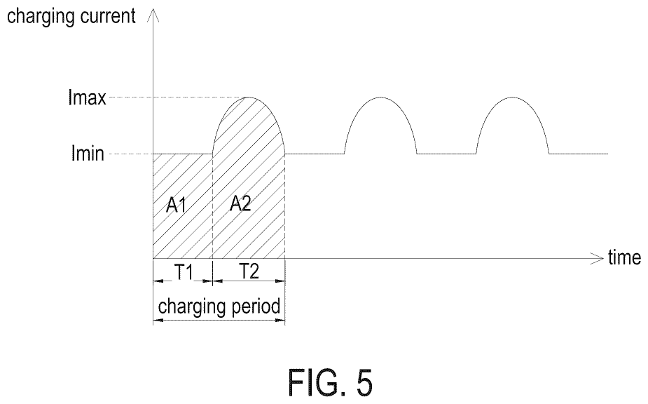

For ease of understanding the charging current Io mentioned in the preceding paragraphs, FIG. 5 schematically shows waveforms of the charging current according to an embodiment of the present disclosure. In FIG. 5, the current value Imax represents the maximum value of the charging current Io and equals the sum of the maximum value of the sinusoidal current Is and the DC current Idc, and the current value Imin represents the minimum value of the charging current Io and equals the DC current Idc of the charging current Io. The current value Imax is greater than the current value Imin, and the current value Imin is greater than zero (i.e., the current value of the DC current Idc is greater than zero). As shown in FIG. 5, in the charging current Io, the sinusoidal current Is and the DC current Idc may be adjusted according to different design considerations. In an embodiment, through configuring the current value and frequency of sinusoidal current Is, generated by the sinusoidal current generation circuit 11, and the current value of DC current Idc, generated by the DC current generation circuit 12, the control circuit 10 makes the sum of the charging amount of DC current Idc during time interval T1 (i.e., the area A1 shown in FIG. 5) and the charging amount of sinusoidal current Is during time interval T2 (i.e., the area A2 shown in FIG. 5) remain unchanged. Accordingly, the efficiency of charging the battery 2 is improved while remaining the total charging amount unchanged.

In the above embodiments, the control circuit 10 may configure the sinusoidal current generation circuit 11 to generate sinusoidal waves for appropriate duration. For example, the sinusoidal current generation circuit 11 may generate the sinusoidal signal of sin(2*π*f*t), where f represents the sinusoidal frequency and t represents time. Therefore, during the time interval T1, the control circuit 10 may configure the sinusoidal current generation circuit 11 to generate all or a part of the sinusoidal waves between sin(θ1) and sin(θ2) as the sinusoidal current Is, and charges the battery 2 by the sinusoidal current Is and the DC current Idc, where θ1 and θ2 are appropriate values. For example, the control circuit 10 may configure the sinusoidal current generation circuit 11 to generate positive half sinusoidal waves between sin(0) and sin(π), partial positive half sinusoidal waves between sin(π/8) and sin(7π/8), or two positive half-sinusoidal waves between sin(0) and sin(4*π) as the sinusoidal current Is.

In addition, when the current value of the sinusoidal current Is or the DC current Idc is increased or decreased, the temperature rise of the battery 2 during the charging process would be increased or reduced correspondingly. By contrast, the temperature rise of the battery 2 is more sensitive to the adjustment for the peak value of the sinusoidal current Is. For example, compared to increasing the magnitude of the DC current Idc, increasing the peak value of the sinusoidal current Is would result in a greater increase in the temperature rise of the battery 2. Consequently, by combining the adjustable sinusoidal current Is and DC current Idc, the present disclosure provides higher flexibility in adjusting the temperature rise of battery, which allows to take both the charging efficiency and the temperature rise of the battery 2 during the charging process into consideration.

In summary, the present disclosure provides a battery charging method and device. In the battery charging method and device, the charging efficiency is improved through combining the sinusoidal current and the DC current, and the temperature rise of battery during the charging process may be taken into consideration by adjusting the amplitude of the sinusoidal current and the magnitude of the DC current. Further, by adjusting the frequency of the sinusoidal current to match the equivalent impedance of the battery, the charging efficiency is further improved.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A battery charging method, comprising:
during a first time interval of a charging period, configuring a DC current generation circuit to generate a DC current, and charging a battery by a charging current comprising the DC current; and
during a second time interval of the charging period, configuring a sinusoidal current generation circuit to generate a sinusoidal current, and charging the battery by the charging current comprising the DC current and the sinusoidal current,
wherein a minimum value of the charging current is equal to the DC current.

2. The battery charging method according to claim 1, further comprising: configuring a battery impedance measurement circuit to measure an equivalent impedance of the battery, and according to the equivalent impedance, configuring the sinusoidal current generation circuit to configure a frequency of the sinusoidal current to reduce the equivalent impedance of the battery when charging the battery.

3. The battery charging method according to claim 1, wherein the DC current generated by the DC current generation current is greater than zero.

4. The battery charging method according to claim 1, wherein in the charging period, a sum of a first charging amount of the charging current during the first time interval and a second charging amount of the charging current during the second time interval is a fixed value.

5. A battery charging device, comprising:
a sinusoidal current generation circuit;
a DC current generation circuit; and
a control circuit, coupled to the sinusoidal current generation circuit and the DC current generation circuit,
wherein during a first time interval of a charging period, the control circuit configures the DC current generation circuit to generate a DC current, and a charging current comprising the DC current charges a battery;
during a second time interval of the charging period, the control circuit configures the sinusoidal current generation circuit to generate a sinusoidal current, and the charging current comprising the DC current and the sinusoidal current charges the battery,
wherein a minimum value of the charging current is equal to the DC current.

6. The battery charging device according to claim 5, further comprising a battery impedance measurement circuit coupled to the control circuit, the control circuit configures the battery impedance measurement circuit to measure an equivalent impedance of the battery, and according to the equivalent impedance, the control circuit configures the sinusoidal current generation circuit to configure a frequency of the sinusoidal current to reduce the equivalent impedance of the battery when charging the battery.

7. The battery charging device according to claim 5, wherein the control circuit controls the DC current generated by the DC current generation current to be greater than zero.

8. The battery charging device according to claim 5, wherein in the charging period, the control circuit configures the sinusoidal current generation circuit and the DC current generation circuit to make a sum of a first charging amount of the charging current during the first time interval and a second charging amount of the charging current during the second time interval be a fixed value.
